(19) United States
(12) Patent Application Publication
(10) Pub. No.: US 2008/0172432 A1
(43) Pub. Date: Jul. 17, 2008

(54) Methods Of Managing Data Objects

(75) Inventors: Winfried Antonius Henricus Berkvens, Eindhoven (NL); Alexander Sinitsyn, Eindhoven (NL); Arjan Claassen, Eindhoven (NL); Jozef Pieter Van Gassel, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/908,444

(22) PCT Filed: Mar. 16, 2006
(86) PCT No.: PCT/IB2006/050825

§ 371 Date: Sep. 12, 2007

(30) Foreign Application Priority Data
Mar. 18, 2005 (EP) 05102183.0

(51) Int. Cl. G06F 17/30

(52) U.S. Cl. 707/206; 707/E17.009

(57) ABSTRACT

There is described a method of managing data objects in a portable device (20) which is operable to be periodically synchronized to a host device (10). The method comprises steps of: (a) establishing a database for storing a record of the data objects and associated numbers of times said data objects are rendered to users or consumed by users (80) of the devices (10, 20); (b) determining whether or not a given data object of said data objects is rendered or consumed more than a threshold number of times; and (c) deleting said given data object from at least one of said portable device (20) and said host device (10) when said given data object is found to have been rendered or consumed more than said threshold number of times. The method is relevant to devices provided with limited data storage capacity, for example personal data assistants (PDAs), palm-top computers, mobile telephones and such like.

The present invention relates to methods of managing data objects in portable devices and host devices. Moreover, the invention also relates to portable devices and host devices operable according to the methods.

Portable electronic devices operable to provide their users with both information and entertainment have recently become increasingly popular. Such devices are conveniently referred to as being “Infotainment Devices”, and can encompass contemporary mobile telephones and audio-visual jukeboxes. Moreover, such devices can be used to store data objects, such objects often being referred to as being data assets. On account of the infotainment devices being portable, they are capable of transporting data objects, namely data assets, from one physical location to another. However, a technical characteristic of infotainment devices is that their storage capacity is less than corresponding host devices to which they are designed to synchronize periodically.

Users of infotainment devices are confronted with a dilemma when using their devices in practice in that a mismatch in storage capacity is often encountered between their infotainment devices and corresponding host devices. The users have to make choices between which data objects are to be synchronized between their infotainment devices and corresponding host devices. Moreover, there is a tendency for limited data storage capacity provided in portable infotainment devices to become filled with data objects, especially if older data objects or data objects infrequently accessed are allowed to accumulate with time.

Automated policies and strategies for managing data objects between host devices and corresponding infotainment devices are known. Moreover, various strategies for synchronizing data between host devices and infotainment devices are known.

In a published United States patent application no. US 2003/0167318, there are described methods of intelligently synchronizing media players, namely infotainment devices, with their corresponding host computers. In one method described, synchronization can be automatically initiated and performed upon connection of a data link between a media player and a host computer. During synchronization, checks are made to determine whether or not new media, namely new data objects, has been received at the media player from the host computer. The checks determine whether or not new media items have been or are presently being received. When the checks determine that such new media items have not been received, such new items can be awaited for synchronization. Whilst waiting for new media items, the media player can, but need not, perform other data storage operations for non-synchronization purposes. More generally, other data storage operations can occur concurrently with synchronization operations. Conversely, when the checks determine that new media items have been received at the media player from the host computer, then the new media items and their associated media attributes are stored on the media player. For example, the new media items are stored to files in the media player, and the associated media attributes pertaining to the media items are stored in a media database residing on the media player. Additionally, any unneeded media items and their associated media attributes can be removed from the media player. Hence, by synchronizing the media content residing on the media player with that on the host computer, new media items are not only stored on the media player, but unneeded (for example old) media items and their associated media attributes are also removed from the media player.

Various policies and strategies are known when filling storage space, for example hard drive disk memory capacity, of portable infotainment devices; as elucidated in the foregoing, such storage space is often relatively restricted in such devices. One example strategy relates to “generate play-list of the day” and “take along the latest news broadcast”. Other strategies are possible, such as strategies to clean up the storage space of portable infotainment devices automatically, for example “remove the least recently used data objects”.

However, these various strategies are not optimal and often an inappropriate allocation of portable infotainment device storage capacity occurs.

It is preferred to provide a method of managing data objects in portable devices, for example portable infotainment devices.

According to a first aspect of the invention, there is provided a method of managing data objects in a portable device which is operable to be periodically synchronized to a host device, said method comprising steps of:

(a) establishing one or more databases for storing a record of the data objects and associated numbers of times said data objects are rendered to users or consumed by users of the devices;
(b) determining from said one or more databases whether or not a given data object of said data objects is rendered or consumed more than a threshold number of times; and
(c) deleting said given data object from at least one of said portable device and said host device when said given data object is found to have been rendered or consumed more than said threshold number of times.

The invention is of advantage in that data objects are capable of being automatically deleted, thereby circumventing an accumulation of data objects.

Optionally, in the method, the data objects and the associated numbers of times said data objects are rendered or consumed are determined on an individual user basis. For example, the portable device may enable access to more than one authorized user thereto, and determine deletion of data objects in response to rendition or consumption in response to each of the authorized users. For example, a given data object is not deleted from the portable device until each authorized user of the device has had an opportunity to render or consume the given data object.

Optionally, in the method, the data objects and the associated numbers of times said data objects are rendered or consumed are determined on a group of users basis. For example, the portable device may enable access to a group of authorized users thereto, and determine deletion of data objects in response to rendition or consumption in response to the group of authorized users. For example, a given data object is deleted from the portable device in response to just one authorized user of the group rendering or consuming the given data object.

Optionally, in the method, rendering or consumption of said given data object occurs at either said portable device or said host device. The method is thus capable of monitoring whether a given data object has been rendered or consumed at the portable device or the host device. For example, a user may only wish to view or watch a day's news report once on either the portable device or the host device but not both.

Optionally, in the method, said one or more databases includes for said given data object parameters for indicating at least one of:

(a) whether or not said given data object is to be subject to deletion in response to rendering or consumption;
(b) an indication of said threshold number of times for said given data object;
(c) an indication of a number of times said given data object has been consumed or rendered; and
(d) an indication of whether consumption or rendering of said data object has occurred at the portable device (20) or at the host device (10).

Such parameters are beneficial to employ when implementing the method in practice on computing hardware.

Optionally, the method includes a step of periodically mutually synchronizing said one or more databases for automatic deletion of said given data object at both the portable device and the host device in response to rendering or consumption thereof. Such synchronization of said one or more databases is beneficial for ensuring that rendered or consumed data objects are efficiently deleted from both the portable device and the host device.

Optionally, in the method, said data objects relate to at least one of data content and executable software applications.

Optionally, in the method, automatic deletion of said given data object results in deletion of a reference to said given data object for scheduled transfer between the portable device and the host device. Such deletion of the reference potentially reduces a number of data objects that need to be transferred between the host device and the portable device for synchronization purposes.

According to a second aspect of the invention, there is provided a portable device including an interface for periodically synchronizing said portable device with a corresponding host device, said portable device including a memory for storing data objects and a database indicative of a number of times said data objects are rendered or consumed, said portable device being operable to automatically delete one or more said data objects in response to said number of times said data objects are rendered or consumed.

According to a third aspect of the invention, there is provided a host device including an interface for periodically synchronizing said host device with a corresponding portable device, said host device including a memory for storing data objects and a database indicative of a number of times said data objects are rendered or consumed, said host device being operable to automatically delete one or more said data objects in response to said number of times said data objects are rendered or consumed.

According to a fourth aspect of the invention, there is provided software recorded on a data carrier, said software being executable on computing hardware for implementing a method according to the first aspect of the invention.

It will be appreciated that features of the invention are susceptible to being combined in any combination without departing from the scope of the invention.

Embodiments of the invention will now be described, by way of example only, with reference to the following drawings wherein:

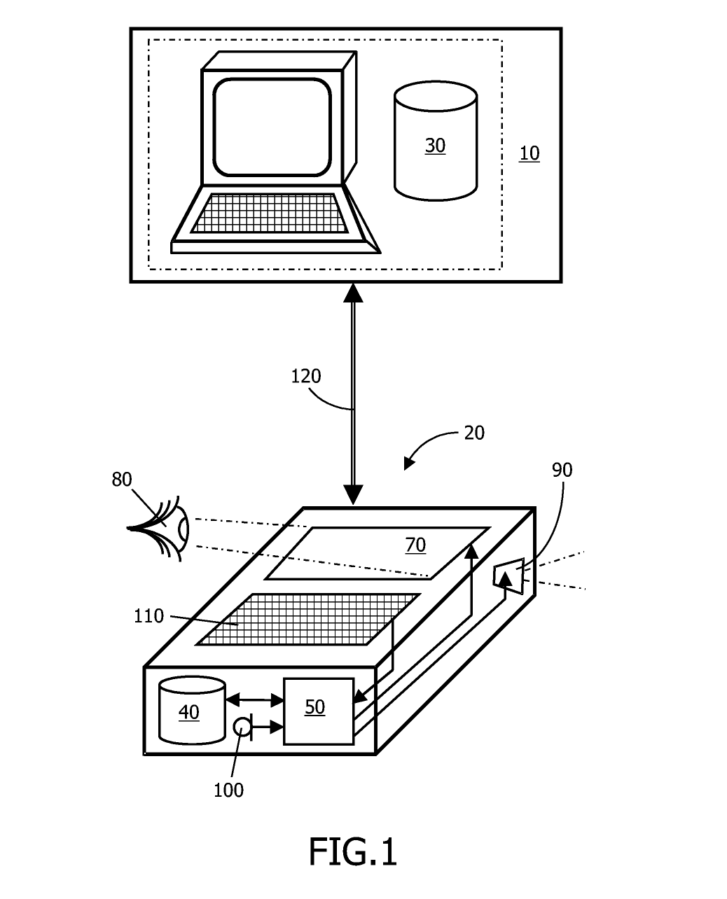

FIG. 1 is a schematic illustration of a system comprising a host computer and an infotainment device operable according to a method of managing data objects according to the present invention; and

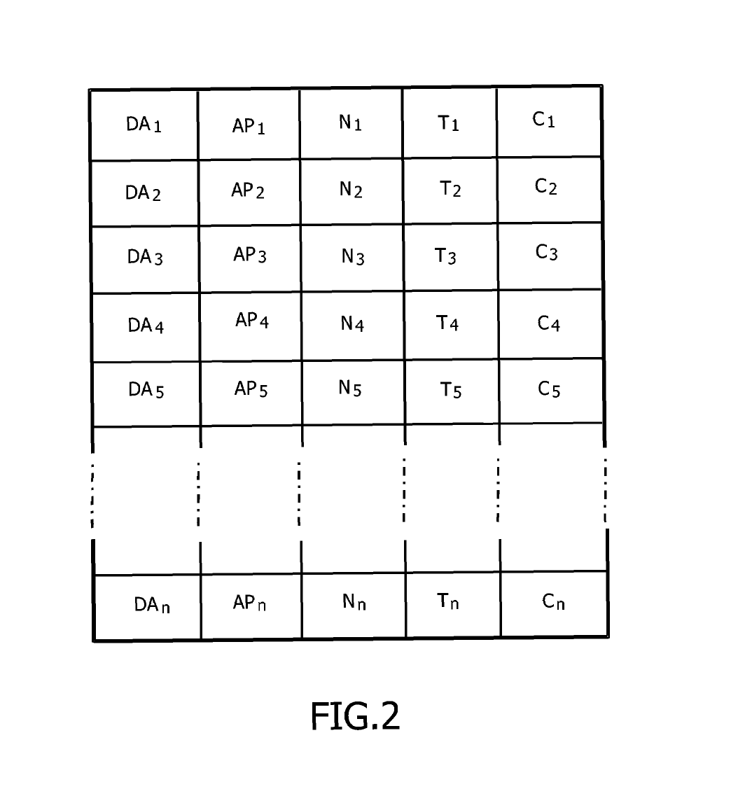

FIG. 2 is an illustration of a parameter list, namely database, for use in managing data objects within the system illustrated in FIG. 1.

In describing embodiments of the present invention, it is convenient firstly to define some relevant technical terms. In the context of the invention, a data object relates to a defined group of data. The data object can comprise:

(a) data which relates to content; and
(b) data which relates to executable software.

Data relating to content can, for example, be data corresponding to compressed video and/or audio. Data relating to executable software is often referred to as being a software application. Software applications can be executed within computing hardware, for example a data processor, included within portable infotainment devices. The computing hardware is operable to execute software applications which access data relating to content for presenting audio-visual information to users of such portable infotainment devices.

When data relating to content is presented to users of such portable infotainment devices, the data relating to content is said to be “rendered” or “consumed”. Similarly, when data relating to software is executed, namely a software object is executed, it is also said to be “rendered” or “consumed”. Moreover, aforesaid data objects are often conveniently referred to as being “assets”.

Referring to FIG. 1, there is shown a host computer denoted by 10 and a portable infotainment device denoted by 20. The host computer 10 includes a data store 30, for example a high-capacity hard disc drive, on which assets, namely data objects, are stored. Moreover, the infotainment device 20 also includes an on-board data store 40 together with a processor 50 and a user interface 60 including a screen 70 for presenting images to a user 80, a sound transducer 90 for outputting sound to the user 80, a sound sensor 100 for receiving sounds emitted from the user 80 together with one or more controls, switches and/or keypads 110 for inputting instructions or control signals into the device 20. The data store 40, on account of physical size and energy consumption constraints, is smaller in data storage capacity than the data store 30 of the host computer 10.

The host computer 10 is, for example, a personal computer or lap-top computer located at home premises, whereas the infotainment device 20 is a compact portable battery-powered electronic device which can be hand-held by the user 80 and stored in the user's pocket, handbag, briefcase, rucksack or similar as appropriate. For example, the device 20 is beneficially implemented as a palm-top device akin in physical size to a mobile telephone, namely cell phone.

In operation, the user 80 accumulates assets on the data store 30, for example by downloading data objects from the Internet via a data link 100. Moreover, the user 80 is desirous to have a sub-set of the assets of the data store 30 available on the infotainment device 20, such sub-set being transferred from the host computer 10 to the device 20 by way of a wireless or direct physical data link 120 there between during a process known as “synchronization”. Synchronization is often implemented by the user 80 at periodic intervals, for example daily. Moreover, on account of the sub-set potentially corresponding to a substantial amount of data, it is customary practice to synchronizes only those data objects necessary to achieve synchronization relative to an immediately preceding synchronization of the infotainment device 20 to the host computer 10.

A problem arises in practice in that data objects, namely assets, can accumulate in the data store 40. One conventional approach to prevent an excessive accumulation of data objects in the store 40 is for software executing on the processor 50 to delete data objects which have been stored for a longest period of time within the store 40. Another conventional approach to prevent an excessive accumulation of data objects is for the software executing on the processor 50 to delete data objects which have never been accessed or are infrequently accessed by the user 80. Both these solutions are sub-optimal.

Thus, the inventors have appreciated that it is beneficial to manage data objects, namely assets stored in the data store 40, on the basis of whether or not the data objects have been rendered or consumed, namely accessed for presentation to the user 80. Moreover, the inventors have further appreciated that the user 80 often does not desire to render or consume a given data object at both the host computer 10 and the infotainment device 20; often, rendering of the given data object at one of the computer 10 and the device 20 is sufficient for user-satisfaction.

The inventors have therefore devised for the host computer 10 and the infotainment device 20 to both have respectively data fields for recording whether or not data objects stored in their data stores 30, 40 have been rendered or consumed. These data fields are beneficially subject to synchronization when the computer 10 and the device 20 are mutually coupled together for synchronization purposes. The device 20, and if required similarly the host computer 10, can be operable to delete automatically data objects after they have been rendered provided that the data objects have been appropriately identified, for example labeled, as being subject to such a deletion process.

Various criteria can be established between the host computer 10 and the infotainment device 20 regarding deletion of data objects that have been rendered or consumed, for example:

(a) a data object stored in the host computer 10 or the infotainment device 20 is deleted after being rendered or consumed once to the user 80 there from;
(b) a data object stored in the host computer 10 and the infotainment device 20 is deleted from both the host computer 10 and the infotainment device 20 after being rendered or consumed once to the user 80 on either the host computer 10 or the infotainment device 20;
(c) a data object stored in the host computer 10 or the infotainment device 20 is deleted after being rendered or consumed a defined threshold number of times to the user 80 there from, for example after five renderings; or
(d) a data object stored in the host computer 10 and the infotainment device 20 is deleted from both the host computer 10 and the infotainment device 20 after being rendered or consumed a defined threshold number of times to the user 80 there from.

If required, different data objects which have been identified or labeled as being subject to deletion to one or more renderings as appropriate can have mutually different threshold number of times allotted thereto. For example, a data object providing a pop song synchronized between the computer 10 and the device 20 can be automatically deleted after being rendered or consumed three times to the user 80 whereas a current day's news report can be automatically deleted after being rendered or consumed just once to the user 80, either from the computer 10 or from the device 20.

Thus, in order to implement the present invention, data objects, namely assets, stored in the data stores 30, 40 are each accompanied by a data parameter to indicate whether or not the data objects should be subject to automatic deletion in response to being rendered or consumed, and a further data parameter defining a threshold for the number of times the data objects can be rendered or consumed before deletion and whether or not such rendering or consumption is either at the host computer 10 or the infotainment device 20 or both. The parameters are preferable collated into a data object which is subject to synchronization between the host computer 10 and the infotainment device 20; this data object including the parameters is later referred to as a “database”. Thus, the database can reside both at the host computer 10 and the infotainment device 20 and be subject to synchronization. In this respect, there can at a given instance exist two databases, one at the host computer 10 and the other at the infotainment device 20.

The data object including the parameters can be, for example, implemented as represented schematically in FIG. 2 wherein each data object (DA), for example software application or data relating to content, in a list of n data objects has:

(a) a first parameter (AP) indicative of whether or not the data object to which it relates is to be subject to deletion in response to consumption, namely rendering, thereof;
(b) a second parameter (N) indicative of how many times the data object can be rendered before deletion thereof is implemented;
(c) a third parameters (T) indicative of one or more times at which the data object was consumed, namely rendered;
(d) a fourth parameter (C) indicative of whether consumption is counted as occurring either at the host computer 10 or at the infotainment device 20, or as occurring at the host computer 10 and the infotainment device 20.

It will be appreciated that other configurations for such a list, namely database, are also feasible and within the scope of the present invention. Moreover, if required, one or more of parameters N, T and C can be omitted from the list and default values assumed.

The present invention will now be described by way of some more specific examples. In operation, the present invention is used to remove content from the device 20 that has been copied to this device 20 earlier. Removal of the content is based on knowledge that the content has already been played back, namely rendered or consumed, to the user 80 on another device, for example the device 20. The present invention is applicable to assets, namely data objects, such as:

(a) one-time-view video material, for example movies, news broadcasts, episodes of a series;
(b) fast ageing content, for example electronic newspapers, SMS messages.

For the present invention to be implemented, a data management structure is employed to track which assets have been rendered, for example played back, viewed, read. Moreover, the management structure is operable to identify which user has consumed an asset, namely to which user a data object has been rendered in a situation where there is more than one user. Furthermore, the management system is also operable to record when a given asset, namely data object, has been consumed, namely rendered.

The management structure is optionally implemented so that the user 80 specifically in a user interface (UI) operation can manually indicate that a given asset has been consumed, namely rendered. Such an indication of which assets, namely data objects, have been consumed is beneficially stored in a database maintained by synchronization between the stores 30, 40.

Thus, the following steps can be used in connection with such a structure:

(a) each time an asset is rendered by the user 80 in a stationary environment, for example the host computer 10, the environment indicates for the asset such rendering in the database;
(b) at a moment a portable device belonging to the user 80, for example the device 20, is synchronized to the stationary environment, there is checked for each qualifying asset whether or not the asset has been rendered by the user 80 since a last time that synchronization was performed with the portable device; and
(c) if the asset is found to have been rendered, the rendered asset will not be further rendered on the portable device and the asset is no longer needed on the portable device and can therefore be deleted.

In a situation where a rendered asset was scheduled to be transferred during synchronization from the environment to the portable device but has not yet been transferred, the rendered asset can be removed from a list of scheduled asset transfers. Such a removal from the list of scheduled transfers assists to prevent unnecessary transfers of assets that have already been consumer by the user 80.

The present invention can also be implemented in other ways. In the aforesaid stationary environment, each time an asset is rendered by the user 80, for example in the host computer 10, the environment indicates for the asset such rendering in the database. Thus, the database at the environment includes a snap-shot of a corresponding database of the portable device, for example the infotainment device 20. A snap-shot is defined as a copy of the database of a device X and located on a device Y, the database on device Y to be synchronized with the database on the device X at a moment the devices A and Y are mutually connected for synchronization purposes. The rendering of assets can be communicated in such snap-shots.

Although, in the foregoing, synchronization of assets stored in the device 20 relative to assets stored in the host computer 10 is described, it will be appreciated that the present invention is applicable to deleting assets stored in the host computer 10 in response to the assets being consumed, namely rendered, on the infotainment device 20.

The present invention is applicable to all situations where assets, namely data objects, are transported on devices provided with limited storage capacity. Thus, the present invention is not only applicable to infotainment devices such as palm-top computers, play-stations, electronic books, but also mobile telephones, cell phones and such like.

Optionally, the data objects and the associated numbers of times said data objects are rendered or consumed are determined on an individual user basis. For example, the portable device 20 may enable access to more than one authorized user thereto, and determine deletion of data objects in response to rendition or consumption in response to each of the authorized users. For example, a given data object is not deleted from the portable device 20 until each authorized user of the device 20 has had an opportunity to render or consume the given data object.

Optionally, the data objects and the associated numbers of times said data objects are rendered or consumed are determined on a group of users basis. For example, the portable device 20 may enable access to a group of authorized users thereto, and determine deletion of data objects in response to rendition or consumption in response to the group of authorized users. For example, a given data object is deleted from the portable device 20 in response to just one authorized user of the group rendering or consuming the given data object.

It will be appreciated that embodiments of the invention described in the foregoing are susceptible to being modified without departing from the scope of the invention as defined by the accompanying claims.

In the accompanying claims, numerals and other symbols included within brackets are included to assist understanding of the claims and are not intended to limit the scope of the claims in any way.

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed to be a reference to the plural and vice versa.

1. A method of managing data objects in a portable device (20) which is operable to be periodically synchronized to a host device (10), said method comprising steps of:
(a) providing or acquiring one or more databases for storing a record of the data objects and associated numbers of times said data objects are rendered to users (80) or consumed by users (80) of the devices (10, 20);
(b) determining from said one or more databases whether or not a given data object of said data objects is rendered or consumed more than a threshold number of times; and
(c) deleting said given data object from at least one of said portable device (20) and said host device (10) when said given data object is found to have been rendered or consumed more than said threshold number of times.

2. A method as claimed in claim 1, wherein the data objects and the associated numbers of times said data objects are rendered or consumed are determined on an individual user basis.

3. A method as claimed in claim 1, wherein the data objects and the associated numbers of times said data objects are rendered or consumed are determined on a group of users basis.

4. A method as claimed in claim 1, wherein rendering or consumption of said given data object occurs at either said portable device (20) or said host device (10).

5. A method as claimed in claim 1, wherein said one or more databases includes for said given data object parameters for indicating at least one of:
(a) whether or not said given data object is to be subject to deletion in response to rendering or consumption;
(b) an indication of said threshold number of times for said given data object;
(c) an indication of a number of times said given data object has been consumed or rendered; and
(d) an indication of whether consumption or rendering of said data object has occurred at the portable device (20) or at the host device (10).

6. A method as claimed in claim 1, including a step of periodically mutually synchronizing said one or more databases for automatic deletion of said given data object at both the portable device (20) and the host device (10) in response to rendering or consumption thereof.

7. A method as claimed in claim 1, wherein said data objects relate to at least one of data content and executable software applications.

8. A method as claimed in claim 1, wherein automatic deletion of said given data object results in deletion of a reference to said given data object for scheduled transfer between the portable device (20) and the host device (10).

9. A portable device (20) including an interface (120) for periodically synchronizing said portable device (20) with a corresponding host device (10), said portable device (20) including a memory (40) for storing data objects and a database indicative of a number of times said data objects are rendered or consumed, said portable device (20) being operable to automatically delete one or more said data objects in response to said number of times said data objects are rendered or consumed.

10. A host device (10) including an interface (120) for periodically synchronizing said host device (10) with a corresponding portable device (20), said host device (10) including a memory (30) for storing data objects and a database indicative of a number of times said data objects are rendered or consumed, said host device (10) being operable to automatically delete one or more said data objects in response to said number of times said data objects are rendered or consumed.

11. Software recorded on a data carrier, said software being executable on computing hardware for implementing a method as claimed in claim 1.

12. Computer programme product comprising instructions that are executable on computing hardware for implementing a method as claimed in claim 1,

13. Record carrier carrying the computer programme product as claimed in claim 12.
